(19) United States
(12) Patent Application Publication
(10) Pub. No.: US 2018/0005437 A1
(43) Pub. Date: Jan. 4, 2018

(54) VIRTUAL MANIPULATOR RENDERING

(71) Applicant: Glen J. Anderson, Beaverton`, OR (US)

(72) Inventor: Glen J. Anderson, Beaverton`, OR (US)

(21) Appl. No.: 15/198,715

(22) Filed: Jun. 30, 2016

(51) Int. Cl. G06T 19/00; G06F 3/01; G02B 27/01; G06T 1/20

(52) U.S. Cl. CPC G06T 19/006; G06T 1/20; G06F 3/017; G02B 27/017; G06F 3/013; G02B 2027/014; G02B 2027/0178

(57) ABSTRACT

System and techniques for virtual manipulator rendering are described herein. A scene is presented to a user via a display. A biometric data set may then be obtained. Here, the biometric data set includes a position of a body part of the user. A representation of a user extremity in the scene may be modified based on the biometric dataset.

### TECHNICAL FIELD

Embodiments described herein generally user interfaces and more specifically to virtual manipulator rendering.

### BACKGROUND

Virtual reality is a family of technologies in which a user is immersed in a simulated environment. Generally, virtual reality at least includes a visualization system whereby the user may look around by moving her head or eyes and see different parts of the environment. Virtual reality may include additional immersive elements, such as haptic interaction with virtual objects or sounds who rendering simulates a virtual origin in relation to the user's position. Augmented reality combines elements of virtual reality with actual reality, such as displaying a virtual sculpture on a real shelf. Head Mounted Displays (HMDs) are generally worn by users to provide the display or sound environment to a user to implement augmented reality or virtual reality. HMDs may also include one or more sensors to facilitate user positioning or perceptive elements (e.g., the user's gaze) within the environment.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates an example environment including a system for virtual manipulator rendering, according to an embodiment.

FIG. 2 is an HMD, according to an embodiment.

FIG. 3 is another HMD, according to embodiment.

FIG. 4 illustrates a block diagram of example HMD system components, according to an embodiment.

FIGS. 5-8 illustrate several examples of virtual manipulator renderings.

FIG. 9 illustrates an example of a method for virtual manipulator rendering, according to an embodiment.

FIG. 10 illustrates an example of a method for virtual manipulator rendering, according to an embodiment.

FIG. 11 is a block diagram illustrating an example of a machine upon which one or more embodiments may be implemented.

### DETAILED DESCRIPTION

Virtual reality augmented by modern HMDs is a rapidly evolving area of interest. Various techniques that are evolving include presenting user extremities, such as her hands, in an avatar rendered in a HMD, as well as implementing virtual input devices (e.g., keyboards). These techniques, however, are generally tied to faithfully modeling and presenting real objects in the virtual environment.

What is needed are techniques to modify these objects to enhance user experience based on the underlying real objects. To address the issues noted above, a system may represent hand(s) differently relative to their position in the user's visual focus (e.g., field of view (FOV)), relative to detected gestures, relative to detected input devices, or relative to other contextual factors. For example, when a tracking system indicates that the hand(s) are in a lower periphery of the user's FOV near a keyboard (virtual or real), the avatar of the user's hand(s) may morph to include narrower finger tips and longer fingers to facilitate user control when the hand(s) are out of focus. Example implementations may include modifying an extremity representation with respect to user focus; modifying the extremity representation with respect to a current executing gesture, modifying the extremity representation based on use context (e.g., current activity, social context, location, or available (e.g., proximate) input devices); modifying the extremity representation when at a surface previously turned into a virtual input device via a gesture. Additional details and examples are given below.

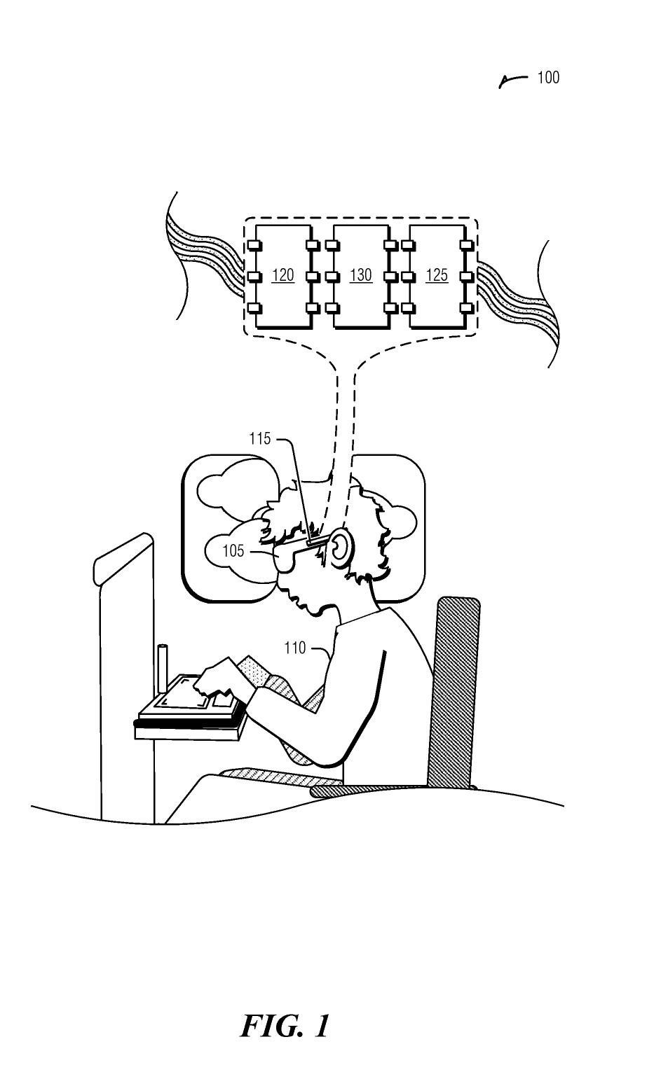

FIG. 1 illustrates an example environment including a system 115 for virtual manipulator rendering, according to an embodiment. The system 115 may be integrated into a HMD 105 worn by a user 110. In an example, the system 115 may be communicatively coupled (e.g., via wireless or wired connection) to the HMD 105 when in operation.

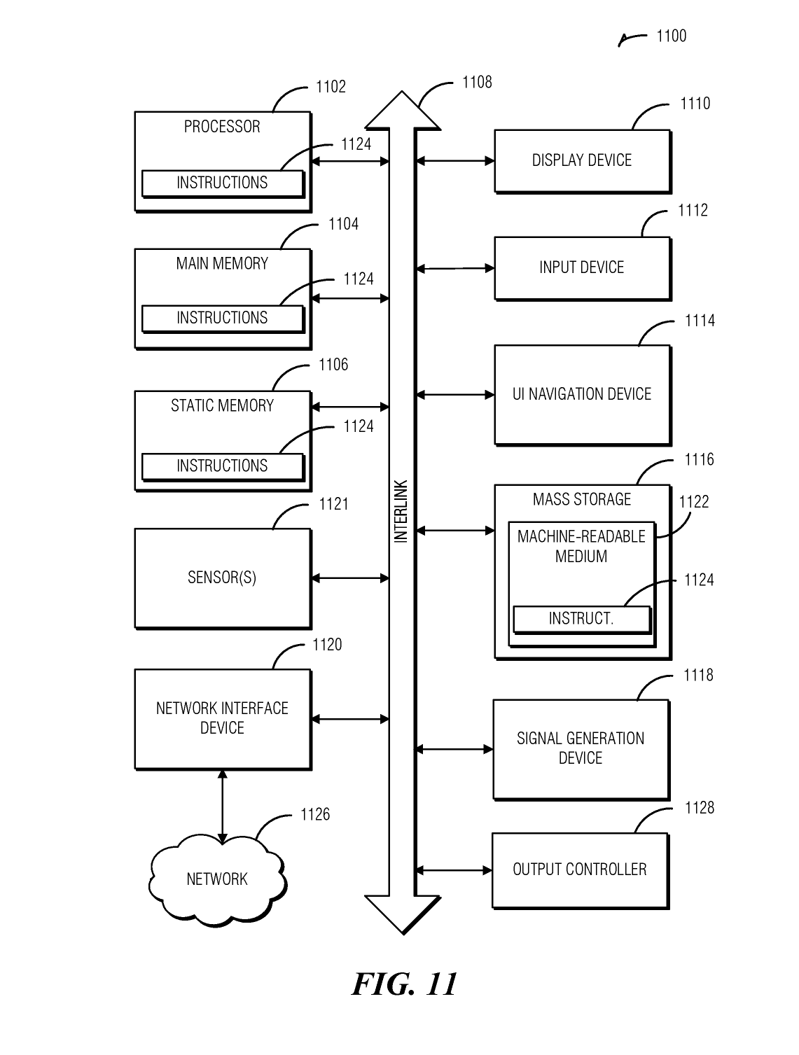

The system 115 includes a rendering pipeline 120, a receiver 125, and an integrator 130. These components are implemented in computer hardware, such as that described below with respect to FIG. 11 (e.g., processor, circuitry, FPGA, etc.). The rendering pipeline 120 may include components such as a graphics processing unit (GPU), physics engine, shaders, etc., and is arranged to display a scene to the user 110, for example, via a display in the HMD 105.

The receiver 125 is arranged to obtain (e.g., retrieve or receive) a biometric data set. The biometric data set is created from sensor data of the user 110, such as may be obtained via wearable devices or observed via one or more cameras. This data includes a position of a body part of the user. The position is derived from raw data, such as accelerometer or gyrometer readings, that are subjected to a model to determine the position. Example models may include statistical models, neural networks, threshold models, classifiers, etc.

In an example, the body part is an eye. Here, the biometric data set identifies a gaze target (e.g., from the eye's position) of the user 110 in the scene. The gaze target is a point or area determined to be the visual focus of the user within the scene, although the user's peripheral vision may capture additional scene elements. Generally, as used herein, relative distances (e.g., near, far, close, etc.) are in relation to the gaze target in the FOV. In an example, the body part is an extremity whose representation will be modified by the integrator 130. In this example, the biometric data set identifies a gesture, or position, formed by the user 110 using the extremity.

In an example, the receiver 125 may also be arranged to obtain a context data set. The context data set includes information other than biometric data for the user 110 that may be used to modify the representation of the extremity to greater effectiveness for the user 110. For example, if the user 110 is using a particular application, such as watching a video, that generally as limited use for the extremity, an extremity representation and modification to reduce distractions to the user 110 may be selected by the integrator 130. In an example, the context data set includes a time of day. In an example, the context data set includes a current location of the user 110. In an example, the current location is geographic (e.g., a city, state, country, etc.). This may be useful as, for example, some cultures dislike the use of certain gestures or even which hand is represented for certain activities, and thus these cultural offenses may be avoided. In an example, the context data set includes a current activity of the user 110. Example activities may include being active (e.g., riding a bicycle, skiing, walking in town, etc.) or inactive (e.g., sitting on a couch). In an example, the context data set includes a current application providing content to the scene. This will typically include an application providing the scene (e.g., a virtual reality simulation) or an application providing some sub-content to the scene (e.g., a video player providing video to a virtual movie screen in the scene).

The integrator 130 is arranged to modify a representation of a user extremity in the scene based on the biometric data set obtained by the receiver 125. In an example, the integrator 130 selects the representation for the extremity from a plurality of representations. Thus, a given extremity may include a predefined number of representations, such as a biosimilar representation (e.g., the representation looks like a foot when the extremity is a foot), to a bio-related representation (e.g., the representation looks like a wing when the extremity is an arm), to an alternative representation (e.g., the representation looks like a pointed stick when the extremity is a nose). In an example, the extremity is a hand.

In examples where the body part is the eye and a gaze target is identified, the representation modifications or representations may be selected as a function of the gaze target. In an example, the integrator 130 is arranged to shrink (e.g., relative to a default of native size) the representation as a function of distance from the gaze target. For example, bio-similar hands may be shrunk as they move closer to the gaze target in order to avoid obscuring the user's view of the scene. The dame representation may grow, for example, as it moves to the periphery in order to allow the user to control the representation when not looking directly at the representation. Conversely, in an example, the representation may shrink the farther it moves from the gaze target. This may help in removing user distractions when, for example, her hands are put in her lap while watching a video. Related to size modifications, transparency modifications may also be effectuated by the integrator 130. In an example, the integrator 130 is arranged to increase transparency of the representation as a function of distance between the gaze target and a position of the representation in the scene. In an example, the integrator 130 is arranged to hide (e.g., not display) the representation when the distance is beyond a threshold. This may occur either when the representation is too close to the gaze target or too far in different examples.

In an example, the representation modification may include selecting a different representation. For example, the integrator 130 may be arranged to change the representation from a bio-similar representation (e.g., a representation that looks like the corresponding extremity as defined by species) to a tool representation. In an example, the tool representation selection occurs when the distance between the representation and the gaze target is beyond (e.g., closer or farther) a threshold. In an example, the tool representation is selected from a plurality of tool representation based on an input type proximate to the representation's position in the scene. For example, if the user 110 is watching a video, and looks at the control console of the player, and moves her hands to that console, the hands may be represented as a remote control. However, if the user is not looking at the console, yet still moves her hands to the console, the remote control may not be selected as it may simply be distracting to the user 110.

In examples where the body part observed in the biometric data set is the extremity whose representation is modified (or another extremity), and a gesture is detected, the gesture may provide the selection criteria for the modification or selection of the representation. For example, if the user 110 performs a rotational gesture, (with her hands) to rotate a displayed image, the representation may change from the hands to a rotating set of arrows and a degree of rotational from the origin. In an example, the integrator 130 is arranged to change the representation from a bio-similar representation to a tool representation. In an example, the tool representation is selected from a plurality of tool representations based on the gesture.

In an example, the integrator 130 is arranged to also use a gaze target present in the biometric dataset to change the position of the representation within the scene. For example, if the user performs a pinching gesture the integrator 130 may implement a pinching tool to represent the extremity. However, when the gaze target is away from the actual position of the user's extremity in the scene, the pinching tool is moved to be at, or near, the gaze target to provide the user feedback without, for example, excessive arm or hand movements. Thus, for example, while looking through an album of pictures, the user 110 may simply shift her gaze, or turn her head, to select each picture to examine. She may perform a pinching gesture in her lap to increase or decrease a zoom on any given picture without having to move her hands to each picture individually.

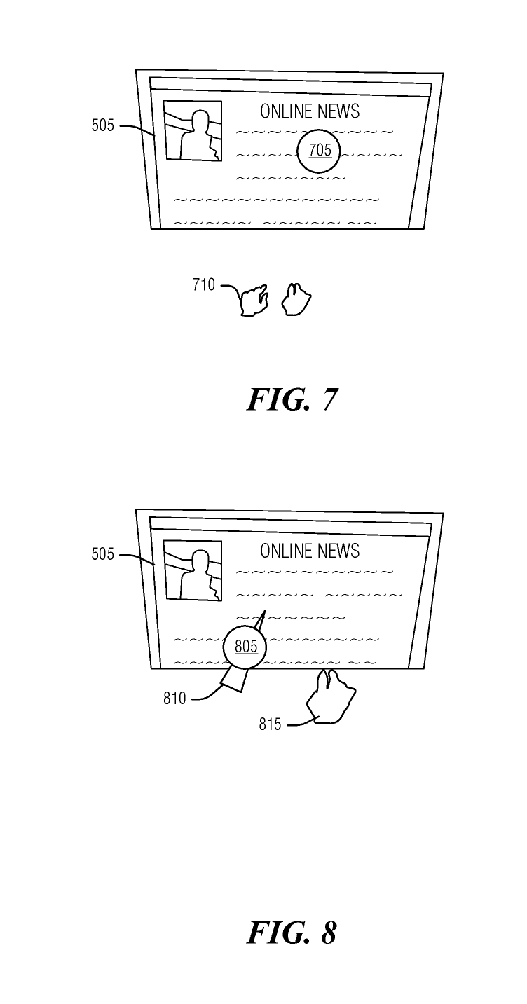

By incorporating user focus (e.g., gaze) and gestures to modifying extremity representations in a virtual or augmented reality scene, the user experience may be improved over existing techniques. Additional examples are presented below with respect to FIGS. 5-8.

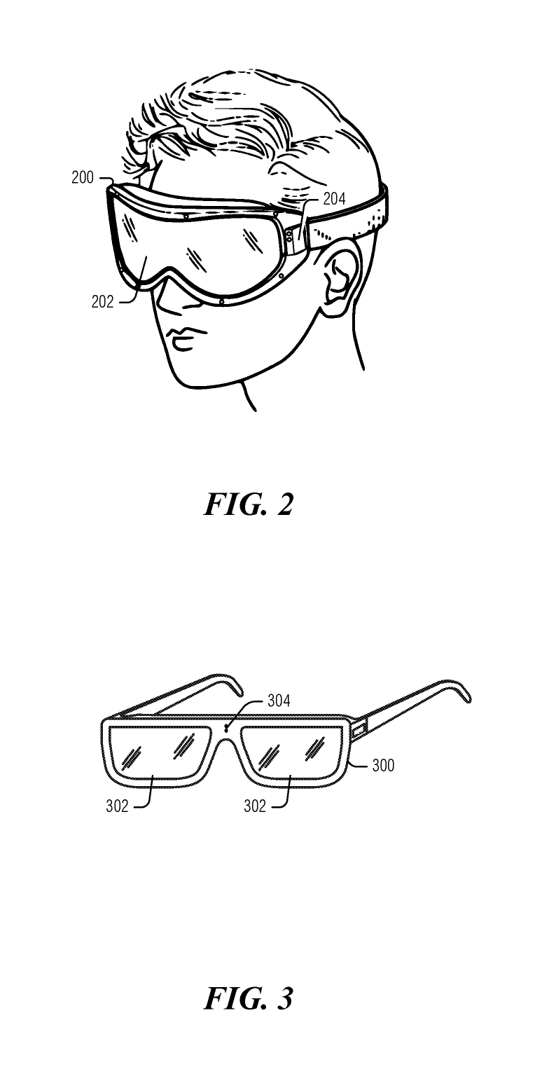

FIG. 2 is an HMD 200, according to an embodiment. The HMD 200 includes a display surface 202, a camera array 204, and processing circuitry (not shown). An image or multiple images may be projected onto the display surface 202, such as by a microdisplay. Alternatively, some or all of the display surface 202 may be an active display (e.g., an organic light-emitting diode (OLED)) display able to produce an image in front of the user. The display also may be provided using retinal projection of various types of light, using a range of mechanisms, including (but not limited to) waveguides, scanning raster, color-separation and other mechanisms.

The camera array 204 may include one or more cameras able to capture visible light, infrared, or the like, and may be used as 2D or 3D cameras (e.g., depth camera). The camera array 204 may be configured to detect a gesture made by the user (wearer).

An inward-facing camera array (not shown) may be used to track eye movement and determine directionality of eye gaze. Gaze detection may be performed using a non-contact, optical method to determine eye motion. Infrared light may be reflected from the user's eye and sensed by an inward-facing video camera or some other optical sensor. The information is then analyzed to extract eye rotation based on the changes in the reflections from the user's retina. Another implementation may use video to track eye movement by analyzing a corneal reflection (e.g., the first Purkinje image) and the center of the pupil. Use of multiple Purkinje reflections may be used as a more sensitive eye tracking method. Other tracking methods may also be used, such as tracking retinal blood vessels, infrared tracking, or near-infrared tracking techniques. A user may calibrate the user's eye positions before actual use.

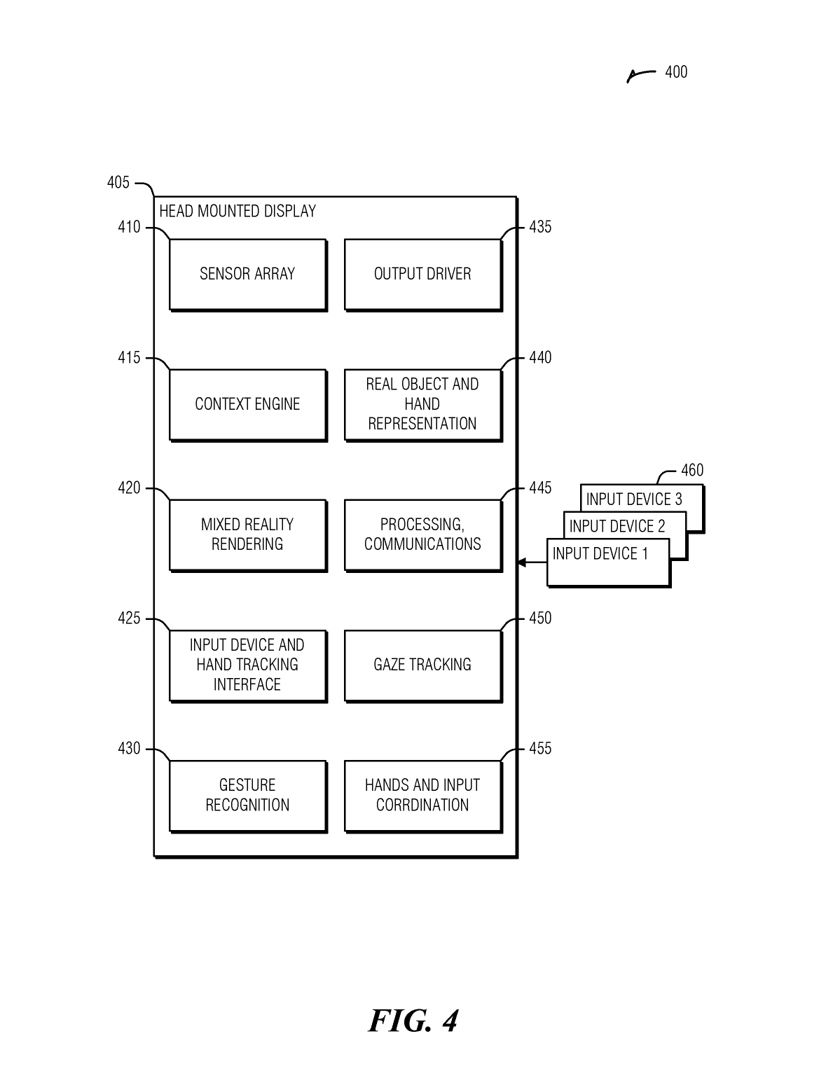

FIG. 3 is another HMD 300, according to embodiment. The HMD 300 in FIG. 2 is in the form of eyeglasses. Similar to the HMD 200 of FIG. 1, HMD 300 includes two display surfaces 302 and a camera array 304. Processing circuitry and inward facing cameras (not shown) may perform the functions described above.

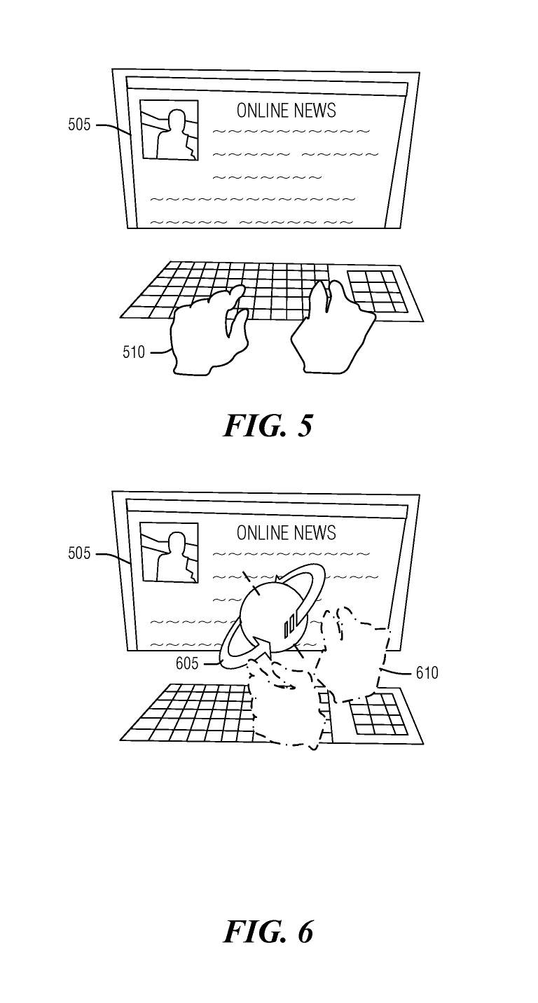

FIG. 4 illustrates a block diagram of an example HMD system 400 components, according to an embodiment. The HMD system 400 includes an HMD 405 and one or more input devices 460. The HMD 405 may include any one or more of a sensor array 410, context engine 415, mixed reality rendering 420, I/O and hand tracking interface 425, gesture recognition 430, output driver 435, object representation 440, processing/communications 445, gaze tracking 450, or extremity and input coordination 455, implemented in computer hardware, such as that described below with respect to FIG. 11 (e.g., circuitry).

The sensor array 410 includes, or interfaces with, sensors such as two or three dimensional cameras, depth cameras, accelerometers, gyrometers, position systems, thermometers, barometers, etc. The output driver 435 drives a display, speaker, haptic device, actuator, etc. The processing/communications 445 provide wired (e.g., via bus) or wireless connectivity outside of the HMD 405, such as to the input devices 460.

The gaze tracking system 450 may include a wearable camera to analyze the user's gaze position. In an example, the gaze tracking 450 may use a center point on an outward facing camera as a proxy for the gaze, essentially using the head position as a gaze position. The gesture recognition 430 may implement existing techniques to identify a gesture, or even identify voice commands and the like. The context engine 415 provides integration from a number of information sources to establish a current context. The information sources may include social network accounts, calendar, operating system (e.g., for current application execution), among others. The object representation 440 provides models or rendering parameters for user avatars or other object representations in a scene.

The coordination component 455 integrates the context 415, tracking 425, and gaze 450 components to control the object representation 440 that is ultimately used by the output 435 to render the scene.

FIGS. 5-8 illustrate several examples of virtual manipulator renderings. FIG. 5 illustrates an unmodified representation 510 in a scene. The scene includes an application interface 505. FIG. 6 illustrates two possible representation modifications. First, the user is performing a gesture. The representation of the gesture may be bio-similar but rendered transparent, such as in the representation 610. In addition, or alternatively, the representation may be change to a tool representation 605. As illustrated, the tool representation 605 does not resemble the extremity (e.g., hands) at all, but rather a representation useful to understand the operation of the gesture, such as rotation in this example.

FIG. 7 illustrates the incorporation of a gaze target 705 in the scene. In this example, the representation 710 is modified by being shrunk because it is not close to the gaze target 705. FIG. 8 illustrates another alternative where the gaze target 805 is on the representation 810 and the representation 810 is near an input device (e.g., the screen). In this example, a tool representation 810 is selected based on these factors. Here, the pointing object is selected to increase user understanding of what is being selected in the application 505. As illustrated the representation 815 of the user's hand remains unchanged because it is not near the gaze target 810.

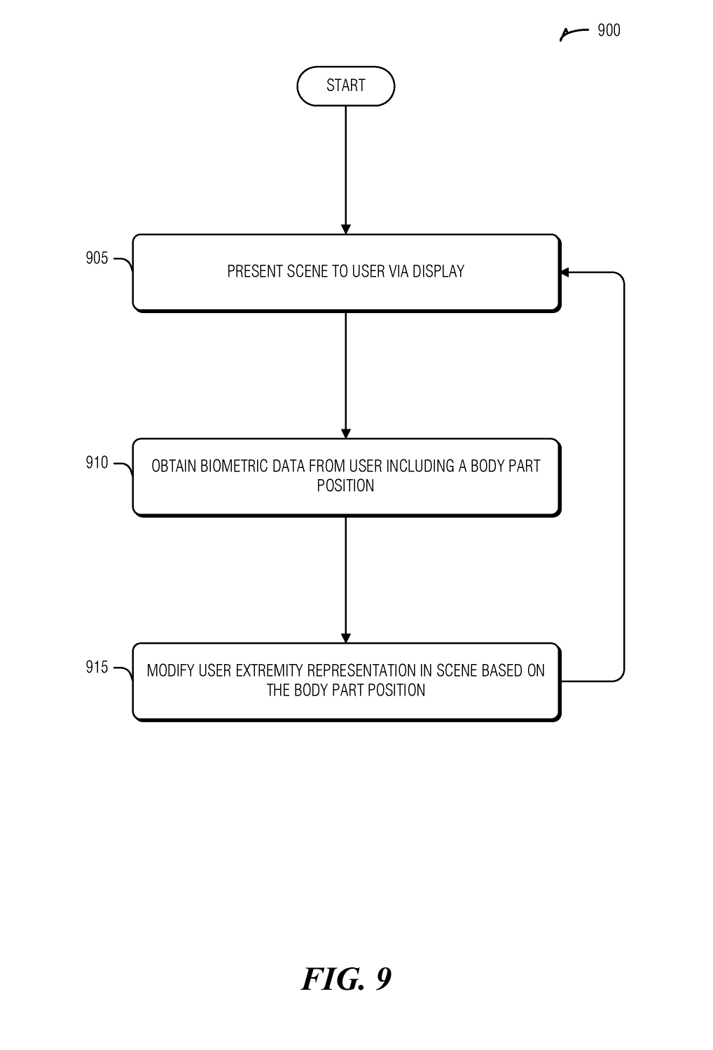

FIG. 9 illustrates an example of a method 900 for virtual manipulator rendering, according to an embodiment. The operations of the method 900 are implemented in computer hardware, such as that described above, or below with respect to FIG. 11 (e.g., circuitry).

At operation 905, a scene is presented to a user via a display.

At operation 910, a biometric data set is obtained. Here, the biometric data set may include a position of a body part of the user, In an example, the body part is an eye. In this example, the biometric data set identifies a gaze target of the user in the scene. In an example, the body part is an extremity of the user (e.g., a hand, finger, foot, leg, arm, etc.). In this example, the biometric dataset identifies a gesture formed by the user using the extremity.

At operation 915, a representation of a user extremity in the scene is modified based on the biometric dataset. In an example, the representation is selected from a plurality of representations for the user extremity. In an example, the user extremity is a hand.

In an example, modifying the representation of the user extremity includes changing the representation from a bio-similar representation to a tool representation when a distance between the gaze target and the representation in the scene is beyond a threshold. In an example, the tool representation is selected from a plurality of tool representations based on an input type proximate to a position of the representation in the scene. In an example, the tool representation is selected from a plurality of tool representations based on the gesture. In an example, modifying the representation of the user extremity includes changing a position to the representation in the scene to coincide with the gaze target of the user.

In an example, modifying the representation of the user extremity includes shrinking the representation as a function of distance between the gaze target and a position of the representation in the scene. In an example, modifying the representation of the user extremity includes increasing transparency of the representation as a function of distance between the gaze target and a position of the representation in the scene. In an example, modifying the representation of the user extremity includes hiding the representation when a distance between the gaze target and the representation in the scene is beyond a threshold.

In an example, the method 900 may be extended to include obtaining a context data set. In this example, the context dataset may include at least one of a time of day, a current location of the user, a current activity of the user, or a current application providing content to the scene. In an example, modifying the representation of the user extremity includes selecting the representation from one of a plurality of representation sets. Here, the one of the plurality of representation sets is selected using at least one member of the context data set.

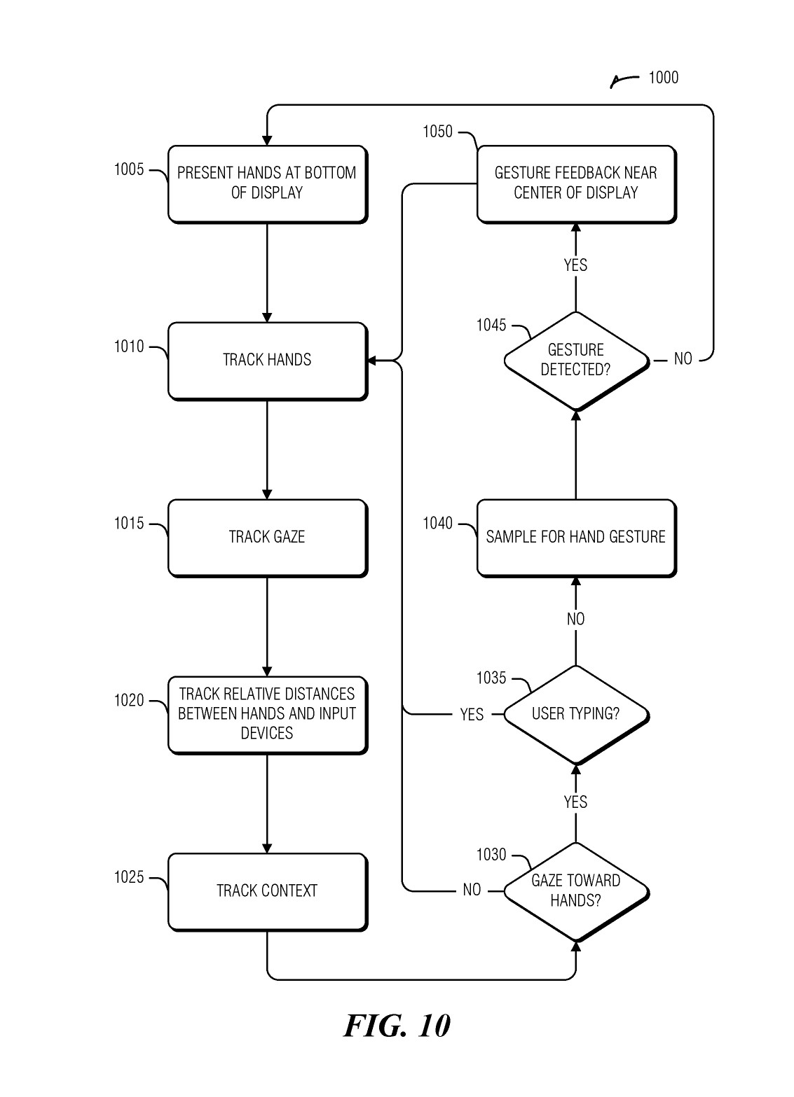

FIG. 10 illustrates an example of a method 1000 for virtual manipulator rendering, according to an embodiment. The operations of the method 1000 are implemented in computer hardware, such as that described above, or below with respect to FIG. 11 (e.g., circuitry). The method 1000 illustrates an example operation that includes gaze tracking, hand tracking, and gesture identification. For example, a user may enter the virtual environment. The user's hands may be initially presented at the bottom of the display (e.g., within the scene) (block 1005). During operation, the user's hands are tracked (block 1010), the user's gaze is tracked (block 1015), relative distances between the user's hands and input devices are tracked (block 1020), and the operational context is tracked (block 1025). Once this data is accumulated, the method 1000 proceeds to use these cues to modify or select a representation for the user's hands in the scene. For example, whether the user gazing at her hands (decision 1030). If not, continue tracking the data sets (block 1010). Else, is the user typing (e.g., interacting with an input device) (decision 1035). If yes, do nothing and continue to accumulate the data sets (block 1010). Else, classify the hand tracking data set (block 1040) to determine whether a gesture is being performed by the user (decision 1045). If there is no gesture detected, move to a default presentation of the hands (block 1005). Else, move the gesture based representation and modification of the user's hands to the center of the display (e.g., at the gaze target).

The specifics illustrated in method 1000 relate the interaction between several possible data sets to selection extremity representations or modifications to those representations. An additional example may include user activities, such as running, involving use of a smart watch as an input device. Data from the watch may change the behavior of the HMD in representing the watch given different gaze positions of the user. For example, the smart watch may include a simple display that contains only the time. However, when the user's gaze is directed to the watch, a large and detailed display may be superimposed over the watch, thus modifying the watch's representation. In another example, the input device may be virtual. For example, the user may gesture on a surface (e.g., wipe her hand across a desk) to signal that the surface is a touch device. In this example, when the user's hand is near (e.g., hovering close to, touching, within a threshold distance, etc.) the hand's representation may be changed to a two pronged stick-like representation to illustrate the two point nature of the surface. In an example, the method may actively illustrate the hands at a FOV periphery (e.g., a certain distance away from a gaze target or a certain distance within the FOV's edge) unless the user is looking at her hands.

FIG. 11 illustrates a block diagram of an example machine 1100 upon which any one or more of the techniques (e.g., methodologies) discussed herein may perform. In alternative embodiments, the machine 1100 may operate as a standalone device or may be connected (e.g., networked) to other machines. In a networked deployment, the machine 1100 may operate in the capacity of a server machine, a client machine, or both in server-client network environments. In an example, the machine 1100 may act as a peer machine in peer-to-peer (P2P) (or other distributed) network environment. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate by, logic or a number of components, or mechanisms. Circuitry is a collection of circuits implemented in tangible entities that include hardware (e.g., simple circuits, gates, logic, etc.). Circuitry membership may be flexible over time and underlying hardware variability. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a computer readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, the computer readable medium is communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time.

Machine (e.g., computer system) 1100 may include a hardware processor 1102 (e.g., a central processing unit (CPU), a graphics processing unit (GPU), a hardware processor core, or any combination thereof), a main memory 1104 and a static memory 1106, some or all of which may communicate with each other via an interlink (e.g., bus) 1108. The machine 1100 may further include a display unit 1110, an alphanumeric input device 1112 (e.g., a keyboard), and a user interface (UI) navigation device 1114 (e.g., a mouse). In an example, the display unit 1110, input device 1112 and UI navigation device 1114 may be a touch screen display. The machine 1100 may additionally include a storage device (e.g., drive unit) 1116, a signal generation device 1118 (e.g., a speaker), a network interface device 1120, and one or more sensors 1121, such as a global positioning system (GPS) sensor, compass, accelerometer, or other sensor. The machine 1100 may include an output controller 1128, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 1116 may include a machine readable medium 1122 on which is stored one or more sets of data structures or instructions 1124 (e.g., software) embodying or utilized by any one or more of the techniques or functions described herein. The instructions 1124 may also reside, completely or at least partially, within the main memory 1104, within static memory 1106, or within the hardware processor 1102 during execution thereof by the machine 1100. In an example, one or any combination of the hardware processor 1102, the main memory 1104, the static memory 1106, or the storage device 1116 may constitute machine readable media.

While the machine readable medium 1122 is illustrated as a single medium, the term “machine readable medium” may include a single medium or multiple media (e.g., a centralized or distributed database, and/or associated caches and servers) configured to store the one or more instructions 1124.

The term “machine readable medium” may include any medium that is capable of storing, encoding, or carrying instructions for execution by the machine 1100 and that cause the machine 1100 to perform any one or more of the techniques of the present disclosure, or that is capable of storing, encoding or carrying data structures used by or associated with such instructions. Non-limiting machine readable medium examples may include solid-state memories, and optical and magnetic media. In an example, a massed machine readable medium comprises a machine readable medium with a plurality of particles having invariant (e.g., rest) mass. Accordingly, massed machine-readable media are not transitory propagating signals. Specific examples of massed machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 1124 may further be transmitted or received over a communications network 1126 using a transmission medium via the network interface device 1120 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 1120 may include one or more physical jacks (e.g., Ethernet, coaxial, or phone jacks) or one or more antennas to connect to the communications network 1126. In an example, the network interface device 1120 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 1100, and includes digital or analog communications signals or other intangible medium to facilitate communication of such software.

### Additional Notes & Examples

Example 1 is a system for virtual manipulator rendering, the system comprising: a rendering pipeline to display a scene to a user; a receiver to obtain a biometric data set, the biometric data set including a position of a body part of the user; and an integrator to modify a representation of a user extremity in the scene based on the biometric dataset, the representation selected from a plurality of representations for the user extremity.

In Example 2, the subject matter of Example 1 optionally includes wherein the user extremity is a hand.

In Example 3, the subject matter of any one or more of Examples 1-2 optionally include wherein the body part is an eye, and wherein the biometric data set identifies a gaze target of the user in the scene.

In Example 4, the subject matter of Example 3 optionally includes wherein to modify the representation of the user extremity includes the integrator to shrink the representation as a function of distance between the gaze target and a position of the representation in the scene.

In Example 5, the subject matter of any one or more of Examples 3-4 optionally include wherein to modify the representation of the user extremity includes the integrator to increase transparency of the representation as a function of distance between the gaze target and a position of the representation in the scene.

In Example 6, the subject matter of any one or more of Examples 3-5 optionally include wherein to modify the representation of the user extremity includes the integrator to hide the representation when a distance between the gaze target and the representation in the scene is beyond a threshold.

In Example 7, the subject matter of any one or more of Examples 3-6 optionally include wherein to modify the representation of the user extremity includes the integrator to change the representation from a bio-similar representation to a tool representation when a distance between the gaze target and the representation in the scene is beyond a threshold.

In Example 8, the subject matter of Example 7 optionally includes wherein the tool representation is selected from a plurality of tool representations based on an input type proximate to a position of the representation in the scene.

In Example 9, the subject matter of any one or more of Examples 1-8 optionally include wherein the body part is the extremity, and wherein the biometric dataset identifies a gesture formed by the user using the extremity.

In Example 10, the subject matter of Example 9 optionally includes wherein to modify the representation of the user extremity includes the integrator to change the representation from a bio-similar representation to a tool representation, the tool representation selected from a plurality of tool representations based on the gesture.

In Example 11, the subject matter of Example 10 optionally includes wherein the biometric data set identifies a gaze target of the user in the scene, and wherein to modify the representation of the user extremity includes the integrator to change a position to the representation in the scene to coincide with the gaze target of the user.

In Example 12, the subject matter of any one or more of Examples 1-11 optionally include wherein the receiver is to obtain a context data set, the context dataset including at least one of a time of day, a current location of the user, a current activity of the user, or a current application providing content to the scene.

In Example 13, the subject matter of Example 12 optionally includes wherein to modify the representation of the user extremity includes the integrator to select the representation from one of a plurality of representation sets, the one of the plurality of representation sets selected using at least one member of the context data set.

Example 14 is a method for virtual manipulator rendering, the method comprising: presenting a scene to a user via a display; obtaining a biometric data set, the biometric data set including a position of a body part of the user; and modifying a representation of a user extremity in the scene based on the biometric dataset, the representation selected from a plurality of representations for the user extremity.

In Example 15, the subject matter of Example 14 optionally includes wherein the user extremity is a hand.

In Example 16, the subject matter of any one or more of Examples 14-15 optionally include wherein the body part is an eye, and wherein the biometric data set identifies a gaze target of the user in the scene.

In Example 17, the subject matter of Example 16 optionally includes wherein modifying the representation of the user extremity includes shrinking the representation as a function of distance between the gaze target and a position of the representation in the scene.

In Example 18, the subject matter of any one or more of Examples 16-17 optionally include wherein modifying the representation of the user extremity includes increasing transparency of the representation as a function of distance between the gaze target and a position of the representation in the scene.

In Example 19, the subject matter of any one or more of Examples 16-18 optionally include wherein modifying the representation of the user extremity includes hiding the representation when a distance between the gaze target and the representation in the scene is beyond a threshold.

In Example 20, the subject matter of any one or more of Examples 16-19 optionally include wherein modifying the representation of the user extremity includes changing the representation from a bio-similar representation to a tool representation when a distance between the gaze target and the representation in the scene is beyond a threshold.

In Example 21, the subject matter of Example 20 optionally includes wherein the tool representation is selected from a plurality of tool representations based on an input type proximate to a position of the representation in the scene.

In Example 22, the subject matter of any one or more of Examples 14-21 optionally include wherein the body part is the extremity, and wherein the biometric dataset identifies a gesture formed by the user using the extremity.

In Example 23, the subject matter of Example 22 optionally includes wherein modifying the representation of the user extremity includes changing the representation from a bio-similar representation to a tool representation, the tool representation selected from a plurality of tool representations based on the gesture.

In Example 24, the subject matter of Example 23 optionally includes wherein the biometric data set identifies a gaze target of the user in the scene, and wherein modifying the representation of the user extremity includes changing a position to the representation in the scene to coincide with the gaze target of the user.

In Example 25, the subject matter of any one or more of Examples 14-24 optionally include obtaining a context data set, the context dataset including at least one of a time of day, a current location of the user, a current activity of the user, or a current application providing content to the scene.

In Example 26, the subject matter of Example 25 optionally includes wherein modifying the representation of the user extremity includes selecting the representation from one of a plurality of representation sets, the one of the plurality of representation sets selected using at least one member of the context data set.

Example 27 is a system comprising means to perform any method of Examples 14-26.

Example 28 is at least one machine readable medium including instructions that, when executed by a machine, cause the machine to implement any method of Examples 14-26.

Example 29 is a system for virtual manipulator rendering, the system comprising: means for presenting a scene to a user via a display; means for obtaining a biometric data set, the biometric data set including a position of a body part of the user; and means for modifying a representation of a user extremity in the scene based on the biometric dataset, the representation selected from a plurality of representations for the user extremity.

In Example 30, the subject matter of Example 29 optionally includes wherein the user extremity is a hand.

In Example 31, the subject matter of any one or more of Examples 29-30 optionally include wherein the body part is an eye, and wherein the biometric data set identifies a gaze target of the user in the scene.

In Example 32, the subject matter of Example 31 optionally includes wherein the means for modifying the representation of the user extremity includes means for shrinking the representation as a function of distance between the gaze target and a position of the representation in the scene.

In Example 33, the subject matter of any one or more of Examples 31-32 optionally include wherein the means for modifying the representation of the user extremity includes means for increasing transparency of the representation as a function of distance between the gaze target and a position of the representation in the scene.

In Example 34, the subject matter of any one or more of Examples 31-33 optionally include wherein the means for modifying the representation of the user extremity includes means for hiding the representation when a distance between the gaze target and the representation in the scene is beyond a threshold.

In Example 35, the subject matter of any one or more of Examples 31-34 optionally include wherein the means for modifying the representation of the user extremity includes means for changing the representation from a bio-similar representation to a tool representation when a distance between the gaze target and the representation in the scene is beyond a threshold.

In Example 36, the subject matter of Example 35 optionally includes wherein the tool representation is selected from a plurality of tool representations based on an input type proximate to a position of the representation in the scene.

In Example 37, the subject matter of any one or more of Examples 29-36 optionally include wherein the body part is the extremity, and wherein the biometric dataset identifies a gesture formed by the user using the extremity.

In Example 38, the subject matter of Example 37 optionally includes wherein the means for modifying the representation of the user extremity includes means for changing the representation from a bio-similar representation to a tool representation, the tool representation selected from a plurality of tool representations based on the gesture.

In Example 39, the subject matter of Example 38 optionally includes wherein the biometric data set identifies a gaze target of the user in the scene, and wherein the means for modifying the representation of the user extremity includes means for changing a position to the representation in the scene to coincide with the gaze target of the user.

In Example 40, the subject matter of any one or more of Examples 29-39 optionally include means for obtaining a context data set, the context dataset including at least one of a time of day, a current location of the user, a current activity of the user, or a current application providing content to the scene.

In Example 41, the subject matter of Example 40 optionally includes wherein the means for modifying the representation of the user extremity includes means for selecting the representation from one of a plurality of representation sets, the one of the plurality of representation sets selected using at least one member of the context data set.

Example 42 is a system comprising means to perform any system of Examples 29-41.

Example 43 is at least one machine readable medium including instructions that, when executed by a machine, cause the machine to implement any system of Examples 29-41.

Example 44 is at least one machine readable medium including instructions for virtual manipulator rendering, the instructions, when executed by a machine, cause the machine to: present a scene to a user via a display; obtain a biometric data set, the biometric data set including a position of a body part of the user; and modify a representation of a user extremity in the scene based on the biometric dataset, the representation selected from a plurality of representations for the user extremity.

In Example 45, the subject matter of Example 44 optionally includes wherein the user extremity is a hand.

In Example 46, the subject matter of any one or more of Examples 44-45 optionally include wherein the body part is an eye, and wherein the biometric data set identifies a gaze target of the user in the scene.

In Example 47, the subject matter of Example 46 optionally includes wherein to modify the representation of the user extremity includes the machine to shrink the representation as a function of distance between the gaze target and a position of the representation in the scene.

In Example 48, the subject matter of any one or more of Examples 46-47 optionally include wherein to modify the representation of the user extremity includes the machine to increase transparency of the representation as a function of distance between the gaze target and a position of the representation in the scene.

In Example 49, the subject matter of any one or more of Examples 46-48 optionally include wherein to modify the representation of the user extremity includes the machine to hide the representation when a distance between the gaze target and the representation in the scene is beyond a threshold.

In Example 50, the subject matter of any one or more of Examples 46-49 optionally include wherein to modify the representation of the user extremity includes the machine to change the representation from a bio-similar representation to a tool representation when a distance between the gaze target and the representation in the scene is beyond a threshold.

In Example 51, the subject matter of Example 50 optionally includes wherein the tool representation is selected from a plurality of tool representations based on an input type proximate to a position of the representation in the scene.

In Example 52, the subject matter of any one or more of Examples 44-51 optionally include wherein the body part is the extremity, and wherein the biometric dataset identifies a gesture formed by the user using the extremity.

In Example 53, the subject matter of Example 52 optionally includes wherein to modify the representation of the user extremity includes the machine to change the representation from a bio-similar representation to a tool representation, the tool representation selected from a plurality of tool representations based on the gesture.

In Example 54, the subject matter of Example 53 optionally includes wherein the biometric data set identifies a gaze target of the user in the scene, and wherein to modify the representation of the user extremity includes the machine to change a position to the representation in the scene to coincide with the gaze target of the user.

In Example 55, the subject matter of any one or more of Examples 44-54 optionally include wherein the instructions cause the machine to obtain a context data set, the context dataset including at least one of a time of day, a current location of the user, a current activity of the user, or a current application providing content to the scene.

In Example 56, the subject matter of Example 55 optionally includes wherein to modify the representation of the user extremity includes the machine to select the representation from one of a plurality of representation sets, the one of the plurality of representation sets selected using at least one member of the context data set.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

What is claimed is:

1. A system for virtual manipulator rendering, the system comprising:
a rendering pipeline to display a scene to a user;
a receiver to obtain a biometric data set, the biometric data set including a position of a body part of the user; and
an integrator to modify a representation of a user extremity in the scene based on the biometric dataset, the representation selected from a plurality of representations for the user extremity.

2. The system of claim 1, wherein the body part is an eye, and wherein the biometric data set identifies a gaze target of the user in the scene.

3. The system of claim 2, wherein to modify the representation of the user extremity includes the integrator to shrink the representation as a function of distance between the gaze target and a position of the representation in the scene.

4. The system of claim 2, wherein to modify the representation of the user extremity includes the integrator to increase transparency of the representation as a function of distance between the gaze target and a position of the representation in the scene.

5. The system of claim 2, wherein to modify the representation of the user extremity includes the integrator to hide the representation when a distance between the gaze target and the representation in the scene is beyond a threshold.

6. The system of claim 2, wherein to modify the representation of the user extremity includes the integrator to change the representation from a bio-similar representation to a tool representation when a distance between the gaze target and the representation in the scene is beyond a threshold.

7. The system of claim 1, wherein the body part is the extremity, and wherein the biometric dataset identifies a gesture formed by the user using the extremity.

8. The system of claim 7, wherein to modify the representation of the user extremity includes the integrator to change the representation from a bio-similar representation to a tool representation, the tool representation selected from a plurality of tool representations based on the gesture.

9. A method for virtual manipulator rendering, the method comprising:
presenting a scene to a user via a display;
obtaining a biometric data set, the biometric data set including a position of a body part of the user; and
modifying a representation of a user extremity in the scene based on the biometric dataset, the representation selected from a plurality of representations for the user extremity.

10. The method of claim 9, wherein the body part is an eye, and wherein the biometric data set identifies a gaze target of the user in the scene.

11. The method of claim 10, wherein modifying the representation of the user extremity includes shrinking the representation as a function of distance between the gaze target and a position of the representation in the scene.

12. The method of claim 10, wherein modifying the representation of the user extremity includes increasing transparency of the representation as a function of distance between the gaze target and a position of the representation in the scene.

13. The method of claim 10, wherein modifying the representation of the user extremity includes hiding the representation when a distance between the gaze target and the representation in the scene is beyond a threshold.

14. The method of claim 10, wherein modifying the representation of the user extremity includes changing the representation from a bio-similar representation to a tool representation when a distance between the gaze target and the representation in the scene is beyond a threshold.

15. The method of claim 9, wherein the body part is the extremity, and wherein the biometric dataset identifies a gesture formed by the user using the extremity.

16. The method of claim 15, wherein modifying the representation of the user extremity includes changing the representation from a bio-similar representation to a tool representation, the tool representation selected from a plurality of tool representations based on the gesture.

17. At least one machine readable medium including instructions for virtual manipulator rendering, the instructions, when executed by a machine, cause the machine to:
present a scene to a user via a display;
obtain a biometric data set, the biometric data set including a position of a body part of the user; and
modify a representation of a user extremity in the scene based on the biometric dataset, the representation selected from a plurality of representations for the user extremity.

18. The at least one machine readable medium of claim 17, wherein the body part is an eye, and wherein the biometric data set identifies a gaze target of the user in the scene.

19. The at least one machine readable medium of claim 18, wherein to modify the representation of the user extremity includes the machine to shrink the representation as a function of distance between the gaze target and a position of the representation in the scene.

20. The at least one machine readable medium of claim 18, wherein to modify the representation of the user extremity includes the machine to increase transparency of the representation as a function of distance between the gaze target and a position of the representation in the scene.

21. The at least one machine readable medium of claim 18, wherein to modify the representation of the user extremity includes the machine to hide the representation when a distance between the gaze target and the representation in the scene is beyond a threshold.

22. The at least one machine readable medium of claim 18, wherein to modify the representation of the user extremity includes the machine to change the representation from a bio-similar representation to a tool representation when a distance between the gaze target and the representation in the scene is beyond a threshold.

23. The at least one machine readable medium of claim 17, wherein the body part is the extremity, and wherein the biometric dataset identifies a gesture formed by the user using the extremity.

24. The at least one machine readable medium of claim 23, wherein to modify the representation of the user extremity includes the machine to change the representation from a bio-similar representation to a tool representation, the tool representation selected from a plurality of tool representations based on the gesture.
